(19) United States
(12) Patent Application Publication
(10) Pub. No.: US 2006/0237949 A1
(43) Pub. Date: Oct. 26, 2006

(54) One hand release mechanism for stroller

(75) Inventors: Hung-Chung Hou, Chaiyi County (TW); Ming-Juan Lee, Tainan County (TW)

Correspondence Address: BIRCH STEWART KOLASCH & BIRCH, PO BOX 747, FALLS CHURCH, VA, 22040-0747, US

(73) Assignee: Link Treasure Limited

(21) Appl. No.: 11/404,900

(22) Filed: Apr. 17, 2006

(30) Foreign Application Priority Data
Apr. 21, 2005 (TW) 094206284

(51) Int. Cl. B62B 7/00

(52) U.S. Cl. 280/642

(57) ABSTRACT

A release mechanism for stroller includes a seat portion comprising a pair of positioning bars disposed transversely for fixedly locking two sides of frame of baby stroller so as to extend the frame in an expanded position. A handle grip is disposed between the pair of positioning bars, wherein the handle grip forces the positioning bars to disengage from two sides of the frame so that the stroller can be folded in a collapsed position. A user has to carry the baby outside of the seat portion before folding the frame since the handle grip is arranged at the seat portion of baby stroller. The structure of the present invention has the advantages of not only folding the stroller by a single hand but avoiding the dangers which might be caused if the user accidentally and inadvertently folds the stroller upon operating.

### FIELD OF THE INVENTION

The present invention relates to a release mechanism for a collapsible stroller. In particular, the mechanism is mounted on a seat portion of the stroller and can be reached to fold by the user with one hand.

### BACKGROUND OF THE INVENTION

Baby strollers usually provide with a frame capable of being extended in an expanded position for carrying babies and of being folded in a collapsed position. When the stroller is operated from an expanded position to a collapsed position, the user has to carry the child outside of the stroller and then to operate a foldable structure of the stroller.

If the child is unable to stand, the user has to carry the child with one hand and to fold the stroller by another hand. In order to overcome the disadvantages, strollers that can be folded by using one hand are also generally seen in the market. Such as Kakuda, U.S. Pat. No. 6,6068,284, discloses a stroller comprising a frame and wheel sets bearing the frame for transportation; it mainly includes a handle bar, front leg tubes, rear leg tubes, sitting tubes, locking devices and a release mechanism, wherein the handle bar has a gripping portion and two lower tubes; the release mechanism is mounted on the gripping portion of the handle bar.

Either expanded or collapsed configuration of the stroller can be achieved by using the release mechanism to lock or unlock the locking devices via the elastic members.

In other words, the release mechanism of strollers in prior art is mounted on the gripping portion of the handle bar, and generally, the gripping portion is pushed by the user to drive the stroller. Therefore, the child sitting inside the stroller might be injured if the user inadvertently pushes the release mechanism while driving the stroller.

### SUMMARY OF THE INVENTION

Therefore, in order to solve the drawbacks of the prior art that the release mechanism is mounted on the gripping portion of the handle bar thus might be pushed inadvertently by the user.

Accordingly, the present invention provides a one hand release mechanism which can be disposed on the seat portion of a collapsible stroller. The release mechanism includes a pair of transverse positioning bars locking two sides of the frame and a handle grip actuating the movement of the positioning bars. Therefore, only if the user takes the child away from the seat portion first, and then can further to control the handle grip to drive the positioning bars moving transversely and further to disengage the positioning bars from two sides of the frame, to collapse the frame and prevent inadvertent unfolding of the stroller by the user.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and, together with the description, serve to explain the principles of the invention.

FIG. 1 is a schematic perspective view of the present invention;

FIG. 2 is an exploded perspective view of the stroller installed the one hand release mechanism according to the present invention;

FIG. 3 is an inner side schematic view of the handle grip according to the present invention;

FIG. 4 is a cross sectional view of the release mechanism, wherein the frame is in an expanded position according to the present invention;

FIG. 5 is a cross sectional view of the release mechanism when the frame is in a collapsed position according to the present invention; and

FIG. 6 is a perspective view of the frame of the present invention after being folded.

### DETAILED DESCRIPTION OF THE PREFERRED EMBODIMENTS

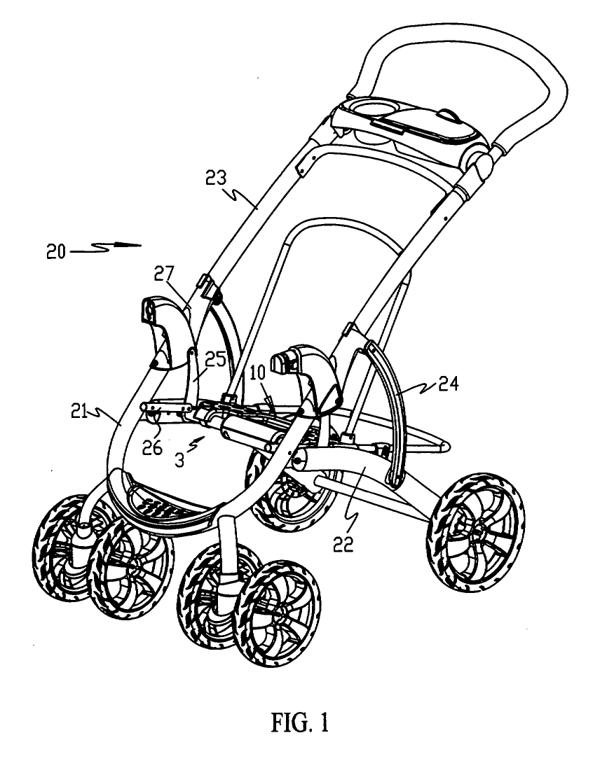

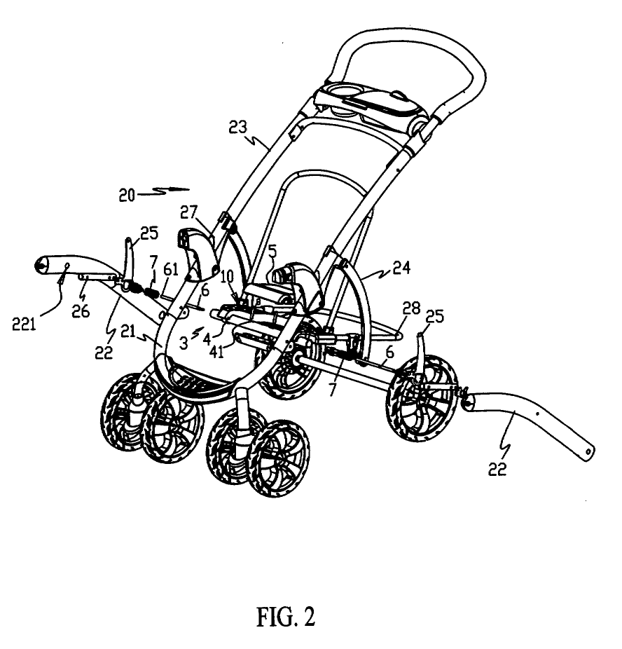

Referring to FIGS. 1 and 2, the present invention of one-handed foldable structure is mounted on a seat portion 10 of a frame of baby stroller so as to allow a user to carry the child outside of the stroller before folding the frame. Therefore, the child injury by inadvertent folding of the stroller can be avoided.

The embodiment of the present invention is provide to be mounted on the seat portion of a foldable stroller, wherein the frame 20 of the foldable stroller may comprises at least a front leg tube 21, a rear leg tube 22, a supporting bar 24, a pair of linkage pieces 25, a seat tube 28 and a linkage bar 26, each pivotally connected to one another to form a linkage foldable frame structure with a seat portion 10.

In the linkage foldable frame structure, a hinge is disposed at the upper end of the front leg tube 21 and is pivotally coupled to a push bar 23; the front end of the rear leg tube 22 pivots to the front leg tube 21; the supporting bar 24 is pivotally coupled between the push bar 23 and rear leg tube 22.

In addition, one end of the linkage piece 25 is pivotally connected to the front leg tube 21, and the seat tube 28 is coupled to rear leg tube 22 and the seat portion 10. According to the present invention, a locking portion 221 can be arranged at the rear leg tube 22, and the locking portion 221 can be a round hole.

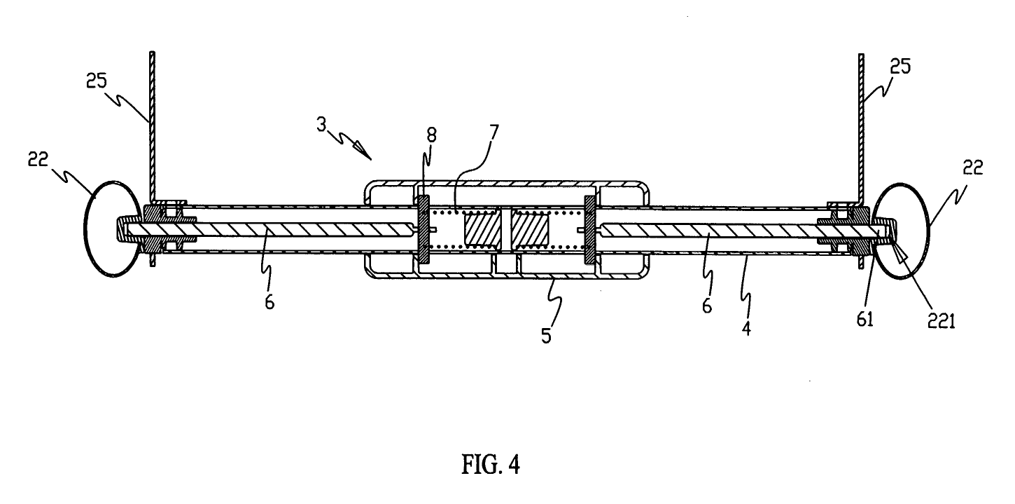

Referring to FIGS. 2, 3, 4 and 5, a release mechanism 3 comprises a transverse tube 4, a handle grip 5, a pair of positioning bars 6, a elastic element 7 and a pair of driving bars 8, wherein the transverse tube 4 is coupled between two sides of the linkage pieces 25; a pair of through slots 41 are located in the transverse tube 4; the pair of positioning bars 6 are transversely moving inside the transverse tube 4.

Each positioning bar 6 has a free ends 61 biased by an elastic element 7 in a locking position with the locking portion 221 of the rear leg tube 22. Another end of each positioning bar 6 is coupled to each of the driving bar 8. The driving bars 8 are movable located inside the pair of slots 41 and extend outside the slots 41. Preferably, the elastic element 7 of this embodiment can be a compression spring.

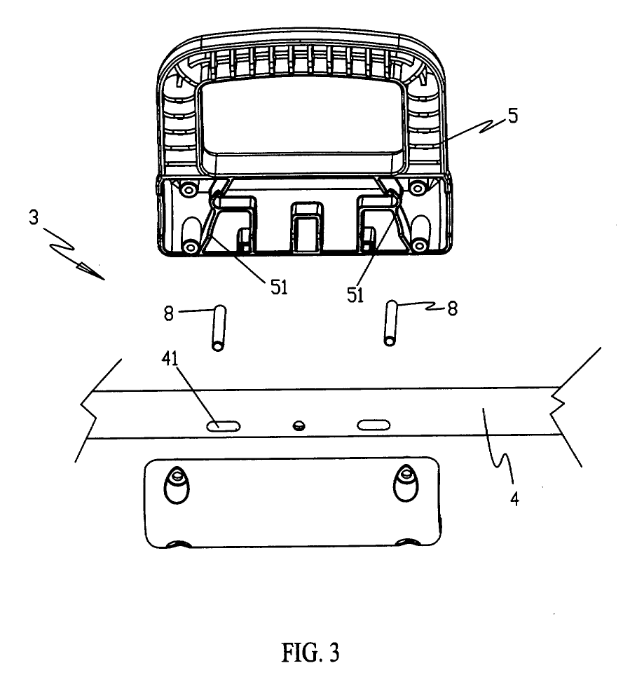

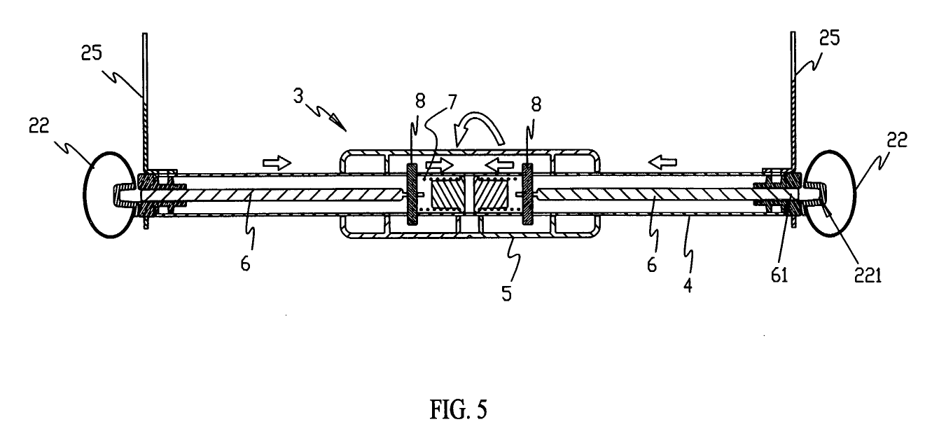

The handle grip 5 includes at least a pair of opposite inclines 51 and is rotatably mounted on the transverse tube 4. As shown in FIG. 3, each positioning bar 8 is located on one side of each of the incline 51. While the handle grip 5 is rotated, the inclines 51 will forcing the driving bars 8 to move toward the centre of the transverse tube 4 and link the positioning bars 6, so as to disengage each the free end 61 of the positioning bars from the locking portion 221 of the rear leg tube 22 as shown in FIG. 5. Therefore, the positioning bars are then unlocked the foldable frame 20, and the frame 20 can then be folded in a collapsed position.

When the foldable frame 20 is extended for use, the release mechanism 3 is in a horizontal position. In order to sit the child with comfort, a seat pad (not shown) is placed upon the release mechanism 3. However, while the user is intended to fold the foldable frame 20, the pad has to be lifted by the user so as to uncover the handle grip 5, and turn the handle grip 5 to link the positioning bars 6, to move transversely toward the centre of the transverse tube 4, to disengage the positioning bars 6 from the locking portion 221. Therefore, the foldable frame 20 is unlocked and to be folded in a collapsed position.

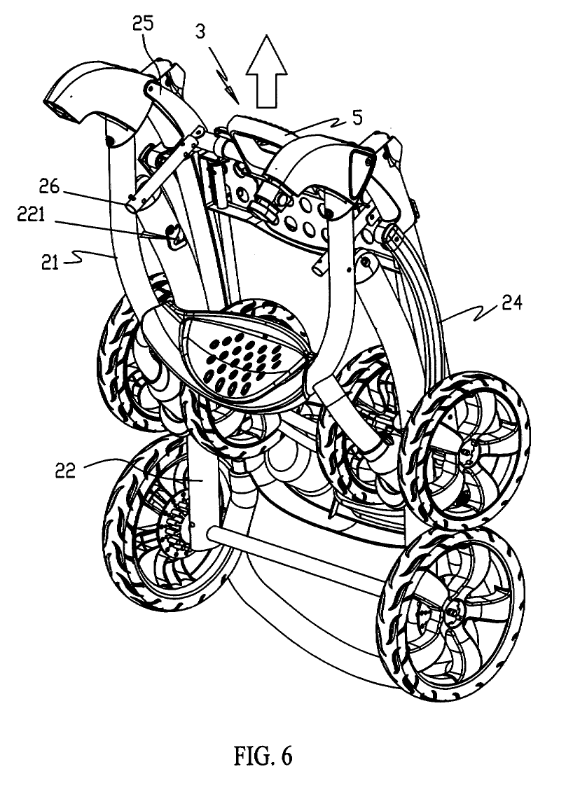

In addition, while turning the handle grip 5 to disengage the positioning bars and unlock the foldable frame 20, the user can pulling the handle grip 5 directly to lift up the foldable frame 20, to rotate each linked tube to be folded in a collapsed position. Moreover, while folding the foldable frame 20, the handle grip 5 is located at top of the foldable frame 20, so that the foldable frame 20 is portable for the user to carry around by lifting the handle grip 5 (as shown in FIG. 6). According to the present invention, it provides a simple operated release mechanism and also prevents inadvertent folding of the foldable frame by the user.

In accordance with the foregoing, the present invention is provided with the handle grip disposed at the seat portion of the foldable frame. For a safety concern, when the foldable frame is expanded, the user can not release the frame before the child leaving the seat portion 10.

As the invention has been described by way of example and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A release mechanism for a stroller having a frame included a seat portion, wherein a locking portion is arranged at the two sides of the seat portion, and the release mechanism mounted on the seat portion comprises a handle grip, an elastic element and a pair of positioning bars; wherein the positioning bars are maintained and locked at the locking portion via an biasing force provided by the elastic element, so as to extend and keep the frame in an expanded position and allow the user to operate the handle grip by one hand to disengage the positioning bars from the locking portion to fold the frame.

2. The release mechanism of claim 1, wherein the frame comprises a front leg tube, a rear leg tube, a push bar, a supporting bar, a linkage piece and a linkage bar, each pivotally connected to one another to form a foldable frame.

3. The release mechanism of claim 1, wherein the locking portion is arranged at an inside surface of the rear leg tube.

4. The release mechanism of claim 1, wherein the locking portion is a round hole.

5. The release mechanism of claim 1, wherein the release mechanism further including a transverse tube and a pair of driving bars coupled to one end of the positioning bars; and the handle grip rotates to move the driving bars to force the positioning bars moving relatively and transversely toward the center of the frame.

6. The release mechanism of claim 5, wherein the transverse tube is connected between the linkage pieces of the frame and the positioning bars are disposed movably inside the transverse tube which is provided with a pair of through slots for moving the driving bar.

7. The release mechanism of claim 1, wherein the handle grip is rotatably disposed on the transverse tube.

8. The release mechanism of claim 1, wherein the handle grip is provided with a pair of opposite inclines received the driving bars to be moved by rotating the handle grip.

9. The release mechanism of claim 1, wherein the positioning bar keeps the frame locked by an elastic element.

10. The release mechanism of claim 1, wherein the elastic element is a compression spring.
